(19) United States
(12) Patent Application Publication
(10) Pub. No.: US 2009/0263761 A1
(43) Pub. Date: Oct. 22, 2009

(54) DENTURE ABUTMENT AND RETENTION SYSTEM

(76) Inventor: JOHN SHEPARD, FORT COLLINS, CO (US)

Correspondence Address: ANCEL W. LEWIS, JR., 425 WEST MULBERRY, SUITE 101, FORT COLLINS, CO, 80521, US

(21) Appl. No.: 12/103,847

(22) Filed: Apr. 16, 2008

(51) Int. Cl. A61C 8/00

(52) U.S. Cl. 433/174

(57) ABSTRACT

A denture retention system includes a denture and an abutment. The denture has an inner channel with an elastic liner having shaped cavities. The cavities have a shaft, a radially outwardly extending ledge surface at the inner end of the shaft and an opening at the outer end of the shaft. The abutment has a shaft portion, a head portion at one end of the shaft portion and a threaded portion at the other end of the shaft portion. The head portion has an undercut surface that extends radially outwardly from the shaft portion. The ledge surface and undercut surfaces overlap and engage one another to retain the denture in the cavity. The threaded part of the abutment threads into an implant or implants into a jaw. The cavity expands when the abutment is inserted or removed from the cavity, and contracts after insertion.

### TECHNICAL FIELD

The present invention relates to dentistry and more particularly to an abutment and system for releasably locating, supporting and retaining a denture.

### BACKGROUND ART

Dental implants are used to support one or more artificial teeth. Implants can help support, stabilize and retain full dentures. Suction aids retention of upper full dentures, but suction is generally inadequate for retention of lower full dentures.

Some prior known implants systems for dentures use a ball shaped abutment that projects from each implant. U.S. Pat. No. 4,787,851 to Kusano, et al. discloses a denture having an inner channel with an elastomeric liner and ball shaped abutments that project into the liner. U.S. Pat. No. 2,112,007 to Adams discloses a denture having an inner channel with snap ring cup sockets and ball shaped abutments that project into the sockets. U.S. Pat. No. 5,049,072 to Lueschen discloses a denture having an inner channel with sockets, o-rings and ball shaped abutments that project into the sockets.

Other prior known implants systems for dentures use two or more implants with abutments and a bar connecting the abutments. U.S. Pat. No. 5,678,997 to De Buck discloses abutments and a bar connecting the abutments, and a plastic rider connected to a denture that snaps onto the bar.

### DISCLOSURE OF THE INVENTION

A denture retention system includes a denture and at least two abutments. The denture has an inner channel with an elastic liner. The abutment has an abutment shaft portion with spaced first and second ends, an abutment head portion at the first end of the abutment shaft portion and a threaded portion that projects from the second end of the abutment shaft portion. The abutment head portion extends radially outwardly relative to the abutment shaft portion and has an undercut surface that extends transversely from the abutment shaft portion. A peripheral surface on the abutment head portion has a plurality of flats for engaging a tool to insert the abutment. The abutment head portion has a smooth, convex end surface. The threaded portion can be sized and shaped to thread into an implant or to thread directly into bone as an implant. The liner of the denture has a denture cavity for each abutment. The cavity has a shape complimentary to the shape of the abutment with a cavity shaft portion and a cavity head portion. The cavity head portion extends radially outwardly relative to the cavity shaft portion and has a ledge surface that extends transversely from the cavity shaft portion. The denture cavity deforms to receive with the undercut surface engaging the ledge surface to retain the denture.

### BRIEF DESCRIPTION OF THE DRAWINGS

Details of this invention are described in connection with the accompanying drawings that bear similar reference numerals in which:

FIG. 1 is a top plan view of a denture retaining system embodying features of the present invention.

FIG. 2 is a bottom plan view of a denture of the system of FIG. 1.

FIG. 3 is a sectional view of the system of FIG. 1 taken along line 3-3.

FIG. 4 is a side elevation view of an abutment of the system of FIG. 1.

FIG. 5 is a top plan view of the abutment of FIG. 4.

FIG. 6 is a bottom plan view of the abutment of FIG. 4.

FIG. 7 is a side elevation view of an implant for the abutment of FIG. 4.

FIG. 8 is a top plan view of the implant of FIG. 7.

FIG. 9 is a side elevation view of another abutment of the system of FIG. 1.

FIG. 10 is a side elevation view of a tool for insertion of the abutment of FIG. 4 or 9.

FIG. 11 is a top plan view of the tool of FIG. 10.

FIG. 12 is a bottom plan view of the tool of FIG. 10.

### DETAILED DESCRIPTION OF THE INVENTION

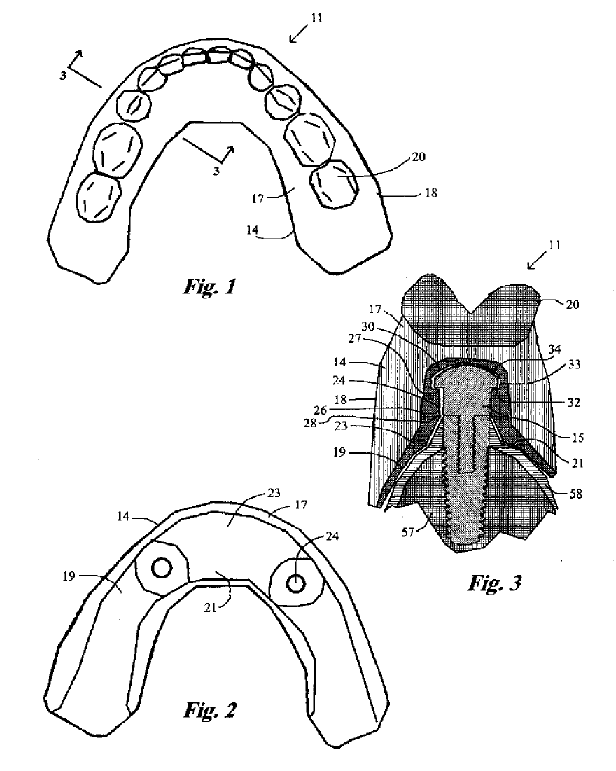

Referring now to FIGS. 1 to 3, a denture retention system 11 includes a denture 14 and abutments 15. The denture 14 has a body 17 with an outer side 18 and a spaced inner side 19. The outer side 18 is shaped to simulate the appearance of gums and a plurality of artificial teeth 20 are mounted on the outer side 18. The inner side 19 has an inner channel 21 that is shaped to receive the gums of a patient. The inner channel 21 includes an elastic liner 23. The liner is made of an elastomer, a natural or synthetic elastic material. The liner is preferably made of a medical silicone. By way of example, and not as a limitation, the liner 23 can be made of Silastic Type A by Dow-Corning.

The liner 23 includes a plurality of spaced, shaped denture cavities 24 that extend inwardly from the inner side 19 toward the outer side 18 of the body 17. The denture cavities 24 are substantially symmetrically positioned relative to the body 17 of the denture 14 and generally two or four denture cavities 24 are provided. Each denture cavity 24 has a cavity shaft portion 26 with spaced first and second ends 27 and 28, and a cavity head portion 30 at the first end 27 of the cavity shaft portion 26. The cavity shaft portion 26 is substantially cylindrical. The second end 28 of the cavity shaft portion 26 opens in the direction away from the outer side 18 of the body 17 of the denture 14.

The cavity head portion 30 extends radially outwardly relative to the cavity shaft portion 26, and has a ledge surface 32, a peripheral surface 33 and an end surface 34. The ledge surface 32 extends transversely, radially outwardly from the first end 27 of the cavity shaft portion 26. The peripheral surface 33 extends transversely from the periphery of the ledge surface 32 to the periphery of the end surface 34. The end surface 34 is preferably concave with a smooth, uninterrupted, low profile dome shape.

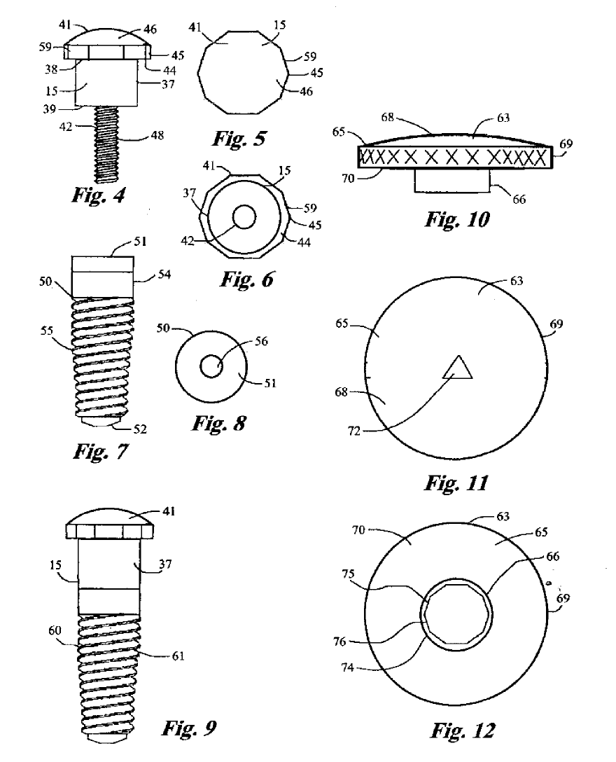

As shown in FIGS. 4 to 6, the abutment 15 includes an abutment shaft portion 37 with spaced first and second ends 38 and 39, an abutment head portion 41 attached to the first end 38 and a threaded portion 42 attached to the second end 39. The abutment shaft portion 37 is substantially cylindrical and the abutment head portion 41 projects radially outwardly relative to the abutment shaft portion 37. The abutment head portion 41 has an undercut surface 44 that extends transversely, radially outwardly from the first end 38 of the abutment shaft portion 37, a peripheral surface 45 that extends transversely from the periphery of the undercut surface 44, and an end surface 46, spaced from the undercut surface 44, that extends radially inwardly from the peripheral surface 45. The threaded portion 42 is cylindrical with external threads 48 and projects axially from the second end 39 of the abutment shaft portion 37.

FIGS. 7 and 8 show an implant 50 having spaced first and second ends 51 and 52. The first end 51 is flat. The implant 50 has a smooth, cylindrical surface 54 adjacent to the first end 51 and external threads 55 from the cylindrical surface 54 to the second end 52. A threaded aperture 56 extends into the implant 50 from the first end 51. The aperture 56 is sized and shaped to receive the threaded portion 42 of the abutment 15.

Referring again to FIG. 3, the cavity shaft portion 26 is sized to snugly fit around the abutment shaft portion 37, and the cavity head portion 30 is sized to snugly fit around the abutment head portion 41.

Preferably the liner 23 of the denture 14 is molded around the abutment shaft portion 37 and the abutment head portion 41 of the abutments 15 so the cavity is of a complementary shape with the shape of the head and shaft portions of the abutment. The ledge surface 32 of the cavity head portion 30 retains the undercut surface 44 of the abutment head portion 41. The elastic liner 23 of the denture 14 stretches to allow removal of the abutments 15 and returns to the original shape after removal. The convex shape of the end surface 46 of the abutment head portion 41 spreads the second end 28 of the cavity shaft portion 26 and aids insertion of the abutment 15 into the denture cavity 24.

The threads 55 of the implant 50 thread into the jaw bone structure 57. The gums 58 extend above the jaw bone structure 57. The length of abutment shaft portion 37 varies depending upon the height of the gums 58 above the jaw bone structure 57.

As shown in FIGS. 4 to 6, the peripheral surface 45 of the abutment head portion 41 includes a plurality of flats 59, for engagement with an insertion tool, described hereinafter. Preferably the peripheral surface 45 of the abutment head portion 41 includes ten to twelve flats 59 instead of the four or six flats on square or hexagon headed bolts. The larger number of flats 59 more closely approximates a circular shape and reduces the possible misalignment of the denture 14 due to misalignment of the peripheral surface 33 of the cavity head portion 30 relative to the peripheral surface 45 of the abutment head portion 41.

FIG. 9 shows a modification to the abutment 15 having a threaded portion 60 with external threads 61. The threaded portion 60 is sized and shaped to thread directly into bone as an implant, replacing the implant 50 described above. This modification is an integral or a one piece body so the abutment and implant is a single piece.

Referring to FIGS. 10 to 12, an insertion tool 63 has a tool head portion 65 and an engagement portion 66. The tool head portion 65 has the shape of a disk with a round, convex top surface 68, a knurled peripheral surface 69 that extends transversely from the periphery of the top surface 68 and a flat bottom surface 70 that is spaced from the top surface 68. A tool aperture 72, sized and shaped to receive a torque tool, extends into the tool head portion 65 from the center of the top surface 68. The tool aperture 72 shown has triangular shape. The tool aperture 72 can have other shapes, such as hexagonal to receive an allen wrench or star shaped to receive a torx wrench. The tool 63 may have a hole to receive a string like dental floss that is tied thereto so the tool is not swallowed.

The engagement portion 66 is a wall that projects from the center of the bottom surface 70 of the tool head portion 65, and has a circular outer surface 74 and a radially inwardly spaced inner surface 75. The inner surface 75 has a plurality of flats 76. The inner surface 75 is sized and shaped to receive and engage the flats 59 of the peripheral surface 45 of the abutment head portion 41 of the abutment 15. The insertion tool 63 facilitates tightening of the abutment 15.

The system 11 provides improved retention over prior known systems without the use of a rigid cup in the denture. Although the system 11 described is directed towards retention of dentures, the abutment 15 can also be used for retention of facial prostheses such as a nose or ear.

Although the present invention has been described with a certain degree of particularity, it is understood that the present disclosure has been made by way of example and that changes in details of structure may be made without departing from the spirit thereof.

What is claimed is:

1. An abutment for retaining a denture having an elastic liner with a cavity having a complementary shape, comprising:
an abutment shaft portion having a first end and a spaced second end,
an abutment head portion attached to said first end of said abutment shaft portion and projecting radially outwardly relative to said abutment shaft portion, said abutment head portion having a substantially flat undercut surface that extends radially outwardly from and transverse to said abutment shaft portion for retaining said abutment head portion in said cavity in said elastic liner of said denture, a peripheral surface that extends transverse to said undercut surface, and a smooth end surface opposite and spaced from said undercut surface for insertion into said cavity in said denture, said end surface being transverse to and connected to said peripheral surface, and
a threaded portion projecting from said second end of said abutment shaft portion and having external threads.

2. The abutment as set forth in claim 1 wherein said threaded portion is sized to thread into an implant in a jaw.

3. The abutment as set forth in claim 1 wherein said threaded portion is sized to thread into a jaw bone structure as an implant.

4. The abutment as set forth in claim 1 wherein said peripheral surface includes a plurality of flats positioned to receive a tool to turn said abutment head portion.

5. The abutment as set forth in claim 4 wherein said peripheral surface has ten said flats.

6. The abutment as set forth in claim 1 wherein said end surface of said abutment head portion is convex to locate and center said abutment head portion upon insertion into said cavity in said elastic liner of said denture and to spread said cavity in said elastic liner of said denture upon insertion.

7. An abutment for retaining a denture comprising:
an abutment shaft portion having a first end and a spaced second end,
an abutment head portion attached to said first end of said abutment shaft portion and projecting radially outwardly relative to said abutment shaft portion, said abutment head portion having a substantially flat undercut surface that extends radially outwardly from and transverse to said abutment shaft portion, a peripheral surface that extends transverse to said undercut surface, and a smooth convex end surface opposite and spaced from said undercut surface, said end surface being transverse to and connected to said peripheral surface, said peripheral surface having ten flats positioned to receive a tool to turn said abutment head portion, and
a threaded portion projecting from said second end of said abutment shaft portion and having external threads, said threaded portion being sized to thread into an implant in a jaw.

8. A denture retaining system comprising:
a denture having an outer side with a plurality of artificial teeth and an inner side having an inner channel with an elastic liner, said liner including at least one shaped denture cavity, said denture cavity having a cavity shaft portion with a first end, a spaced, open second end, and a cavity head portion at said first end of said cavity shaft portion, said cavity head portion having a ledge surface that extends transversely to and radially outwardly from said first end of said cavity shaft portion, and
an abutment for each said cavity, said abutment having an abutment shaft portion with a first end and a spaced second end, an abutment head portion attached to said first end of said abutment shaft portion and projecting radially outwardly relative to said abutment shaft portion, and a threaded portion projecting from said second end of said abutment shaft portion, said abutment head portion having a substantially flat undercut surface that extends radially outwardly from and transverse to said abutment shaft portion, said abutment head portion being sized to extend radially outwardly relative to said cavity shaft portion,
whereby said undercut surface of said abutment head portion and said ledge surface of said cavity head portion engage one another to retain said denture relative to said abutment.

9. The system as set forth in claim 8:
including an implant having a flat first end, a spaced second end, external threads between said first and second ends, and a threaded implant aperture extending into said implant from said first end, said external threads being sized and shaped to implant into a jaw, and
wherein said threaded portion of said abutment is sized and shaped to thread into said implant aperture.

10. The system as set forth in claim 8 wherein said threaded portion of said abutment is sized and shaped to implant into a jaw.

11. The system as set forth in claim 8 wherein said abutment head portion includes a peripheral surface that extends transversely from said undercut surface, said peripheral surface having a plurality of flats.

12. The system as set forth in claim 11 wherein said peripheral surface has ten flats.

13. The system as set forth in claim 11 including an insertion tool having an engagement portion with an inner surface, said inner surface having a plurality of flats and being sized and shaped to engage said flats on said peripheral surface of said abutment head portion to turn said abutment.

14. The system as set forth in claim 13 wherein insertion tool has a tool head portion with a top surface opposite said engagement portion and a tool aperture extending into said tool head portion from said top surface, said tool aperture being sized and shaped to receive a torque imparting tool.

15. The system as set forth in claim 14 wherein said tool aperture is triangular.

16. The system as set forth in claim 8 wherein said abutment head portion has a convex end surface opposite and spaced from said undercut surface.

17. The system as set forth in claim 8 wherein said liner is made of medical silicone.

18. A denture retaining system comprising:
a denture having an outer side with a plurality of artificial teeth and an inner side having an inner channel with a liner of medical silicone, said liner including at least one shaped denture cavity, said denture cavity having a cavity shaft portion with a first end, a spaced, open second end, and a cavity head portion at said first end of said cavity shaft portion, said cavity head portion having a ledge surface that extends transversely to and radially outwardly from said first end of said cavity shaft portion,
an abutment for each said cavity, said abutment having an abutment shaft portion with a first end and a spaced second end, an abutment head portion attached to said first end of said abutment shaft portion and projecting radially outwardly relative to said abutment shaft portion, and a threaded portion projecting from said second end of said abutment shaft portion, said abutment head portion having a substantially flat undercut surface that extends radially outwardly from and transverse to said abutment shaft portion, a peripheral surface that extends transverse to said undercut surface, and a smooth convex end surface opposite and spaced from said undercut surface, said end surface being transverse to and connected to said peripheral surface, said peripheral surface having ten flats, said abutment head portion being sized to extend radially outwardly relative to said cavity shaft portion,
an implant having a flat first end, a spaced second end, external threads between said first and second ends, and a threaded implant aperture extending into said implant from said first end, said external threads being sized and shaped to implant into a jaw, said implant aperture being sized and shaped to receive said threaded portion of said abutment, and
an insertion tool having a tool head portion and an engagement portion attached to said tool head portion, said tool head portion having a top surface opposite said engagement portion and a tool aperture extending into said tool head portion from said top surface, said tool aperture being sized and shaped to receive a torque imparting tool, said engagement portion having an inner surface, said inner surface having a plurality of flats and being sized and shaped to engage said flats on said peripheral surface of said abutment head portion to turn said abutment,
whereby said undercut surface of said abutment head portion and said ledge surface of said cavity head portion retain said denture relative to said abutment.
